(19) United States
(12) Patent Application Publication
(10) Pub. No.: US 2026/0145575 A1
(43) Pub. Date: May 28, 2026

(54) Rechargeable Battery Simulator

(71) Applicant: TOYOTA BATTERY Co., Ltd., Shizuoka (JP)

(72) Inventor: Soichiro Fukamachi, Toyohashi-shi (JP)

(21) Appl. No.: 19/396,152

(22) Filed: Nov. 20, 2025

(30) Foreign Application Priority Data
Nov. 26, 2024 (JP) 2024205340

(51) Int. Cl. B60L 58/12; B60L 50/60

(52) U.S. Cl. CPC B60L 58/12; B60L 50/60; B60L 2240/547; B60L 2240/549

(57) ABSTRACT

A rechargeable battery simulator includes a storage device and a processor. The storage device stores model variables that define an electrochemical model of a rechargeable battery. The processor is configured to execute a concentration variable estimation process. The concentration variable estimation process includes estimating a concentration variable varied by current flowing through the rechargeable battery using an equation in which a predetermined model variable of the model variables has a fixed value. The concentration variable represents a concentration of a predetermined substance at a predetermined location in the rechargeable battery. The equation specifies time variation of the concentration variable.

### CROSS-REFERENCE TO RELATED APPLICATIONS

This application is based upon and claims the benefit of priority from prior Japanese Patent Application No. 2024205340, filed on Nov. 26, 2024, the entire contents of which are incorporated herein by reference.

### BACKGROUND

### 1. Field

The following description relates to a rechargeable battery simulator.

### 2. Description of Related Art

JP2010-169609 describes an example of a device that uses an equivalent circuit of a battery to calculate the electric power that can be input to and output from the battery. The device uses a detection value of a sensor to estimate a parameter of the equivalent circuit. In the device described above, the calculation accuracy of the electric power that can be input to and output from the battery remains low until the estimated value of the parameter of the equivalent circuit converges.

### SUMMARY

Examples of the present disclosure will now be described.

Example 1: A rechargeable battery simulator includes a storage device and a processor. The storage device stores model variables that define an electrochemical model of a rechargeable battery. The processor is configured to execute a concentration variable estimation process. The concentration variable estimation process includes estimating a concentration variable varied by current flowing through the rechargeable battery using an equation in which a predetermined model variable of the model variables has a fixed value. The concentration variable represents a concentration of a predetermined substance at a predetermined location in the rechargeable battery. The equation specifies time variation of the concentration variable.

In the above configuration, the concentration variable is estimated with the equation that is based on the electrochemical model. The electrochemical model is generated based on the design information of the rechargeable battery. Thus, there is no need to collect a vast amount of data of physical quantities related with the actual charging and discharging of the rechargeable battery to optimize the model variables in the equation. This shortens the time for improving the estimation accuracy of the concentration variable, which is varied by the concentration variable estimation process.

The concentration variable estimation process, which is based on the electrochemical model, typically discretizes a differential equation to calculate transitions in the model variables and the physical quantities of the rechargeable battery in fine-grained time intervals. Thus, the concentration variable estimation process, which is based on the electrochemical model, may result in an excessively large computation load. In this regard, the above configuration estimates the concentration variable using the equation with the predetermined model variable having a fixed value. This reduces the computation load.

Example 2. In the rechargeable battery according to the first example, the predetermined model variable includes a diffusion coefficient of a diffusion equation related to the predetermined substance. The concentration variable estimation process includes estimating the concentration variable, varied by current flowing through the rechargeable battery, using the equation in which the diffusion coefficient has a fixed value.

The diffusion coefficient is dependent on the temperature and the concentration of the predetermined substance. Thus, in the concentration variable estimation process, which uses the electrochemical model, the diffusion coefficient is updated each time the concentration variable is calculated. This, however, may result in an excessively large computation load required to calculate the concentration variable after the time as the estimated subject. This increases the merit for using the equation in which the value of the diffusion coefficient is fixed.

Example 3. In the rechargeable battery simulator according to example 1 or 2, the concentration variable represents an ion concentration in a surface of an active material. The storage device stores related data that sets a relationship between the concentration variable and an open-circuit potential. The processor is configured to execute a voltage estimation process. The equation includes a first equation that associates an average concentration of ions in the active material with its first-order time derivative. The concentration variable estimation process includes estimating the average concentration with the first equation and estimating the concentration variable from the estimated average concentration. The voltage estimation process includes estimating a terminal voltage of the rechargeable battery that corresponds to the concentration variable by using the related data.

In the above configuration, the ion concentration in the surface of the active material is estimated to estimate the open-circuit potential. This allows the open-circuit potential to be accurately estimated even if the rechargeable battery is not in a steady state. Further, the terminal voltage is accurately estimated based on the open-circuit potential.

Example 4. In the rechargeable battery simulator according to example 3, the processor is configured to execute a diffusion coefficient setting process. The diffusion coefficient setting process includes setting a diffusion coefficient, as the predetermined model variable, in correspondence with a predetermined discharge voltage. The concentration variable estimation process includes estimating the concentration variable using the diffusion coefficient corresponding to the predetermined discharge voltage. The predetermined discharge voltage is a voltage closer to a discharge termination voltage of the rechargeable battery than a present terminal voltage of the rechargeable battery.

The inventor has found that when fixing the value of the diffusion coefficient and estimating the concentration variable for discharging, the estimation accuracy is improved by fixing the diffusion coefficient to the value of the discharge termination voltage. Thus, the above configuration allows the concentration variable to be accurately estimated when fixing the value of the diffusion coefficient.

Example 5. In the rechargeable battery simulator according to example 3 or 4, the processor is configured to execute a diffusion coefficient setting process. The diffusion coefficient setting process includes setting a diffusion coefficient, as the predetermined model variable, in correspondence with a predetermined charge voltage. The concentration variable estimation process includes estimating the concentration variable using the diffusion coefficient corresponding to the predetermined charge voltage. The predetermined charge voltage is closer to a charge termination voltage of the rechargeable battery than a present terminal voltage of the rechargeable battery.

The inventor has found that when fixing the value of the diffusion coefficient and estimating the concentration variable for charging, the estimation accuracy is improved by fixing the diffusion coefficient to the value of the charge termination voltage. Thus, the above configuration allows the concentration variable to be accurately estimated when fixing the value of the diffusion coefficient.

Example 6. In the rechargeable battery simulator according to any one of examples 3 to 5, the processor is configured to execute a current value setting process and a determination process. The current value setting process includes setting current values of the rechargeable battery as conditions for estimating the concentration variable in the concentration variable estimating process. The determination process includes determining a restriction variable based on the terminal voltage corresponding to the concentration variable estimated using the current values set in the current value setting process. The restriction variable represents a restriction imposed on a current of the rechargeable battery.

In the above structure, the terminal voltage is estimated in accordance with each set current to obtain a value suitable for imposing restrictions on the current.

Example 7. In the rechargeable battery simulator according to any one of examples 3 to 6, in addition to the first equation associating the average concentration of ions with its first-order time derivative, the equation includes a second equation that associates a diffusion level variable with its first-order time derivative, and a third equation that associates the average concentration and the diffusion level variable with the concentration variable. The diffusion level variable represents a diffusion level of the ions in the active material. The concentration variable estimation process includes estimating the average concentration and the diffusion level variable with the first equation and the second equation, and estimating the concentration variable with the third equation based on input variables of the average concentration and the diffusion level variable.

There is a tendency for the calculation accuracy to become low when the charge rate or discharge rate of the rechargeable battery is high if the ion concentration in the surface of the active material is calculated from only the average concentration and the ion flow velocity, which is determined from the current of the rechargeable battery, in the active material. In the above configuration, the ion concentration in the surface of the active material is calculated from the average concentration and the diffusion level variable. This increases the accuracy for calculating the ion concentration in the surface of the active material.

Example 8. In the rechargeable battery simulator according to any one of examples 3 to 7, the processor is configured to repeatedly execute a diffusion coefficient calculation process, an acquisition process, and a concentration variable calculation process. The diffusion coefficient calculation process includes calculating a diffusion coefficient based on the average concentration. The acquisition process includes acquiring a current flowing through the rechargeable battery. The concentration variable calculation process includes calculating an average concentration of ions in the active material using an equation defined by the diffusion coefficient calculated by the diffusion coefficient calculating process based on an input variable of the current. The concentration variable estimation process includes estimating a future value expected at a future time point over a time period that is longer than execution cycles of the diffusion coefficient calculation process, the acquisition process, and the concentration variable calculation process, and using a value calculated through the concentration variable calculation process as an initial value of the average concentration.

In the above configuration, the initial value of the average concentration, which is the input variable of the concentration variable estimation process, is the concentration variable calculated each time the concentration variable calculation process is performed. This increases the estimation accuracy of the average concentration.

Example 9: A vehicle includes the rechargeable battery simulator according to Example 6, drive wheels, a motor generator mechanically coupled to the drive wheels, the secondary battery configured to discharge electric power for driving the motor generator or to be charged with regenerative electric power generated by the motor generator; and a controller configured to control amount of electric power charged to and discharged from the secondary battery. The restriction variable includes a chargeable maximum current and a dischargeable maximum current, and the controller is further configured to set a charge-discharge current of the secondary battery based on the chargeable maximum current and the dischargeable maximum current.

Other features and aspects will be apparent from the following detailed description, the drawings, and the claims.

### BRIEF DESCRIPTION OF THE DRAWINGS

FIG. 1 is a diagram of a vehicle drive system in accordance with one embodiment.

FIG. 2 is a flowchart illustrating a process executed by a battery ECU shown in FIG. 1.

FIG. 3 is a chart illustrating an example of map data used by the battery ECU shown in FIG. 1.

FIG. 4 is a chart illustrating an example of map data used by the battery ECU shown in FIG. 1.

FIG. 5 is a flowchart illustrating a process executed by the battery ECU shown in FIG. 1.

FIG. 6 is a flowchart illustrating a process executed by the battery ECU shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.” A first embodiment will now be described with reference to the drawings.

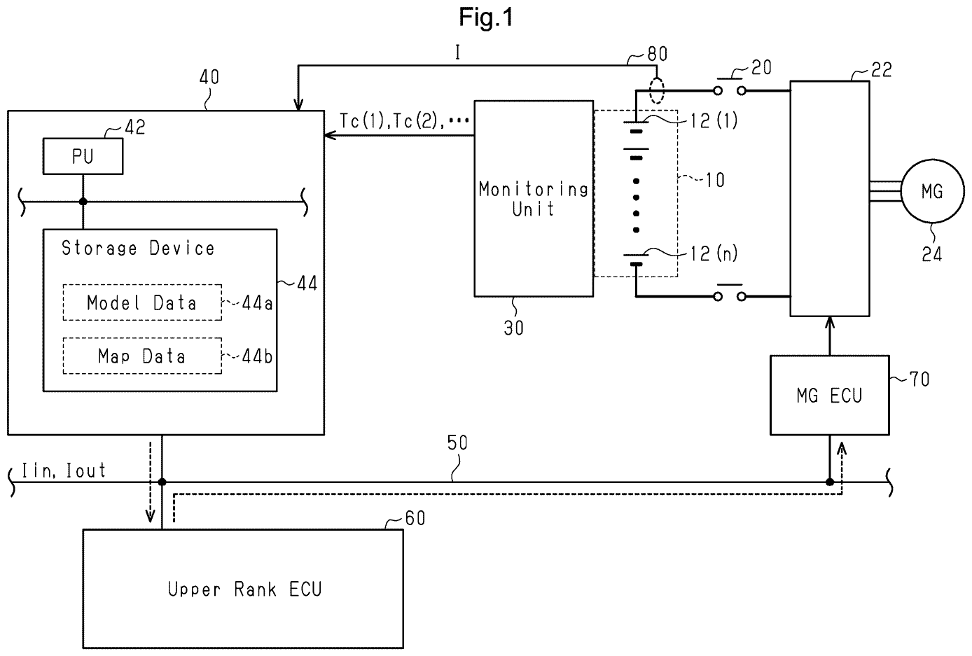

FIG. 1 shows the configuration of a vehicle drive system.

An on-board battery 10 is a series-connected body of battery cells 12(1), 12(2), . . . , and 12(n). The on-board battery 10 may have a terminal voltage of, for example, tens to hundreds of volts. In the battery cells 12(1), 12(2), . . . , and 12(n), each number in the parentheses is used to identify the cell. In the description hereafter, the battery cells 12(1), 12(2), . . . , and 12(n) will collectively be referred to as the battery cells 12. The battery cells 12 are lithium-ion rechargeable batteries.

The on-board battery 10 includes terminals connected by a system main relay 20 to a power converter 22. The power converter 22 supplies electric power from the on-board battery 10 to a motor generator 24. Further, the power converter 22 supplies the electric power generated by the motor generator 24 to the on-board battery 10. The motor generator 24 is mechanically coupled to the drive wheels of the vehicle.

A monitoring unit 30 monitors the state of the battery cells 12(1), 12(2), . . . , and 12(n) in the on-board battery 10.

A battery electronic control unit (ECU) 40 monitors the state of the on-board battery 10. The battery ECU 40 is configured to communicate through an in-vehicle network 50 with an upper rank ECU 60. The upper rank ECU 60 manages electric power for the vehicle drive system. The upper rank ECU 60 sends instructions through the in-vehicle network 50 to a motor generator electronic control unit (MGECU) 70 to control the drive force of the motor generator 24. The control of the drive force also controls the amount of electric power charged to and discharged from the on-board battery 10. Accordingly, the upper rank ECU 60 sends instructions through the in-vehicle network 50 to the MGECU 70 to control the amount of electric power charged to and discharged from the on-board battery 10.

The subject controlled by the MGECU 70 is the motor generator 24. The MGECU 70 operates the power converter 22 to control the controlled quantity, such as torque, of the motor generator 24.

The battery ECU 40 refers to a charge-discharge current I of the on-board battery 10 detected by a current sensor 80. In the example described hereafter, a plus sign will be added to the charge-discharge current I to indicate that the on-board battery 10 is being charged, and a minus sign will be added to the charge-discharge current I to indicate that the on-board battery 10 is being discharged. The battery ECU 40 refers to cell temperatures Tc(1), Tc(2), . . . of the battery cells 12(1), 12(2), . . . , and 12(n) detected by the monitoring unit 30.

The battery ECU 40 includes a processing unit (PU) 42 and a storage device 44. The PU 42 is a software processor such as a CPU. The storage device 44 may be a storage medium such as a rewritable non-volatile memory or a disc medium.

### Battery Cell State Calculation Process

The battery ECU 40 sequentially calculates the state of the battery cells 12 based on an electrochemical model. In particular, the battery ECU 40 sequentially calculates the ion concentration in the active material as the state of the battery cells 12. Thus, the electrochemical model is, for example, a mathematical model based on the porous electrode theory related to Newman et al. It will be assumed here that the active material is spherical. Further, in the present embodiment, as one example, it is assumed that the lithium-ion concentration in the active material is isotropic. Thus, the lithium-ion concentration cp in the positive electrode active material is expressed as a function having the independent variables of distance rp, from the center of the positive electrode active material in the radial direction, and time t. Further, the lithium-ion concentration cn in the negative electrode active material is expressed as a function having the independent variables of distance rn from the center of the negative electrode active material in the radial direction, and time t. The battery ECU 40 sequentially calculates the lithium-ion concentration in the surface of the positive electrode active material. The lithium-ion concentration in the surface of the positive electrode active material is, for example, quantified by the particle size Rp in the positive electrode active material obtained through partial differentiation of the lithium-ion concentration cp with the distance rp. Further, the lithium-ion concentration in the surface of the negative electrode active material is, for example, quantified by the particle size Rn in the negative electrode active material obtained through partial differentiation of the lithium-ion concentration cn with the distance rn.

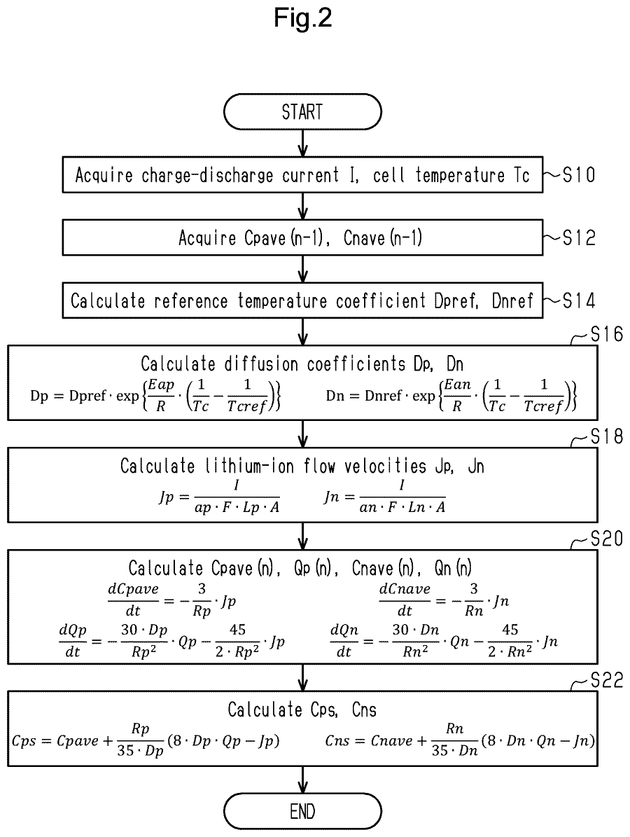

FIG. 2 illustrates a process for calculating the state of the battery cells 12. The process illustrated in FIG. 2 is implemented by, for example, the PU 42 that executes the programs stored in the storage device 44 repeatedly in predetermined cycles. In the following description, the character “S” affixed to a number represents a step number.

In the process illustrated in FIG. 2, the PU 42 first acquires the charge-discharge current I and the cell temperature Tc (S10). The cell temperature Tc is the temperature of one of the battery cells 12 in the on-board battery 10. Then, the PU 42 acquires the preceding average concentration Cpave of the lithium-ions in the positive electrode active material and the preceding average concentration Cnave of the lithium-ions in the negative electrode active material (S12). The preceding value is the value that was acquired when the process of FIG. 2 was executed in the preceding cycle. The average concentration Cpave of the lithium-ions in the positive electrode active material is acquired by dividing the volume integral of the lithium-ion concentration cp in the positive electrode active material by the volume of the active material. Further, the average concentration Cnave of the lithium-ions in the negative electrode active material is acquired by dividing the volume integral of the lithium-ion concentration cn in the negative electrode active material by the volume of the active material. The variable of “n−1” in parentheses after the average concentrations Cpave and Cnave represents the preceding value.

The PU 42 calculates the reference temperature coefficient Dpref of the positive electrode using the preceding value of the average concentration Cpave as an input variable, and calculates the reference temperature coefficient Dnref of the negative electrode using the preceding value of the average concentration Cnave as an input variable (S14). The reference temperature coefficients Dpref and Dnref are diffusion coefficients of the lithium-ion concentration at a reference temperature. More specifically, the PU 42 looks up the reference temperature coefficients Dpref and Dnref in the map data 44b stored in the storage device 44 and shown in FIG. 1. The map data 44b includes data in which the average concentration Cpave is the input variable and the reference temperature coefficient Dpref is the output variable, and data in which the average concentration Cnave is the input variable and the reference temperature coefficient Dnref is the output variable.

The map data is a dataset of discrete values of input variables, and values of output variables corresponding to the values of the input variables. When the value of an input variable matches the value of any one of the input variables in the map data, the value of the corresponding output variable is acquired by lookup in the map data. When the value of an input variable does not match any of the values of the input variables in the map data, the map lookup is performed to acquire a value through interpolation of the output variables in the map data. Instead, the map lookup may be performed such that when the value of an input variable does not match the value of any one of the input variables in the map data, the value of the output variable in the map data corresponding to the value of the closest one of the input variables included in the map data is acquired.

Then, the PU 42 uses equation (c1), which is shown below, to calculate a diffusion coefficient Dp of the positive electrode based on the input variables of the reference temperature coefficient Dpref and the cell temperature Tc (S16). Further, the PU 42 uses equation (c2), which is shown below, to calculate a diffusion coefficient Dn of the negative electrode based on the input variables of the reference temperature coefficient Dnref and the cell temperature Tc(S16).

$$Dp = Dpref \cdot exp \{ Eap / R ( 1 / Tc - 1 / Tref ) \} \qquad ( c1 )$$

$$Dn = Dnref \cdot exp \{ Ean / R ( 1 / Tc - 1 / Tref ) \} \qquad ( c2 )$$

Here, “Eap” and “Ean” represent the electrode activation energy. Further, “Eap” and “Ean” are specified in model data 44a that is stored in the storage device 44. The model data 44a is the data of the model variables defining the electrochemical model. In the above equations, “R” represents the ideal gas constant. Further, “Tref” represents the reference temperature. The reference temperature coefficients Dpref and Dnref, which are described above, are the diffusion coefficients Dp and Dn at the reference temperature Tref.

The PU62 uses equation (c3), which is shown below, to calculate a lithium-ion flow velocity Jp in the positive electrode based on the input variable of the charge-discharge current I (S18). Further, the PU62 uses equation (c4), which is shown below, to calculate a lithium-ion flow velocity Jn in the negative electrode based on the input variable of the charge-discharge current I (S18).

$$Jp = I / ( ap \cdot F \cdot Lp \cdot A ) \qquad ( c3 )$$

$$Jn = I / ( an \cdot F \cdot Ln \cdot A ) \qquad ( c4 )$$

Here, “F” represents the Faraday constant, “A” represents the cross-sectional area, “Lp” represents the positive electrode thickness, “Ln” represents the negative electrode thickness, “ap” represents the positive electrode active material surface area of per unit volume, and “an” represents the negative electrode active material surface area per unit volume. In the equations, “A,” “Lp,” “Ln,” “ap,” and “an” are defined by the model data 44a.

The PU 42 calculates the present average concentrations Cpave and Cnave and the present volume average diffusion fluxes Qp and Qn (S20). The input variables of this process are the lithium-ion flow velocities Jp and Jn, the preceding values of the average concentrations Cpave and Cnave, and the preceding values of the volume average diffusion fluxes Qp and Qn. In the process, the differential equations expressed by equations (c5) and (c6), which are shown below, are converted to difference equations. In equations (c5) and (c6), j represents p or n.

$$\frac{dCjave}{dt} = - \frac{3}{Rj} \cdot Jj \qquad ( c5 )$$

$$\frac{dQj}{dt} = - \frac{30 \cdot Dj}{{Rj}^{2}} \cdot Qj - \frac{45}{2 \cdot {Rj}^{2}} \cdot Jj \qquad ( c6 )$$

The volume average diffusion fluxes Qp and Qn, in quantitative terms, are variables representing the diffusion level of ions in the active material. The volume average diffusion fluxes Qp and Qn are, for example, quantitated by the volume average of the lithium-ion flow velocity in the active material. More specifically, the volume average diffusion flux Qp expresses a value acquired by dividing an integrated value of the diffusion of the lithium-ion concentration cp (rp, t) in the positive electrode active material from the center to the surface of the active material by the volume of the active material. Further, the volume average diffusion flux Qn expresses a value acquired by dividing an integrated value of the diffusion of the lithium-ion concentration cn (rn, t) in the negative electrode active material from the center to the surface of the active material by the volume of the active material. Equations (c5) and (c6), which are shown above, are derived from a diffusion equation expressed by equation (c7), which is related to the lithium-ion concentrations cp and cn and shown below.

$$\frac{\partial cj ( rj , t )}{\partial t} = Dj \cdot \frac{1}{r {j}^{2}} . \frac{\partial }{\partial rj} ( r {j}^{2} \cdot \frac{\partial cj ( rj , t )}{\partial rj} ) \qquad ( c7 )$$

The lithium-ion concentration cj (rj, t) uses a model including an item dependent only on time, an item proportional to the square of distance rj, and an item proportional to the fourth power of the distance rj.

The average concentrations Cpave and Cnave calculated in S20 are acquired during the next cycle in S12, which is shown in FIG. 2.

Then, the PU 42 calculates the surface concentrations Cps and Cns from equation (c8), which is shown below (S22).

$$Cjs = Cjave + \{ R j / ( 35 Dj ) \} \cdot ( 8 Dj \cdot Qj - Jj ) \qquad ( c8 )$$

When S22 is completed, the PU 42 ends the process of FIG. 2.

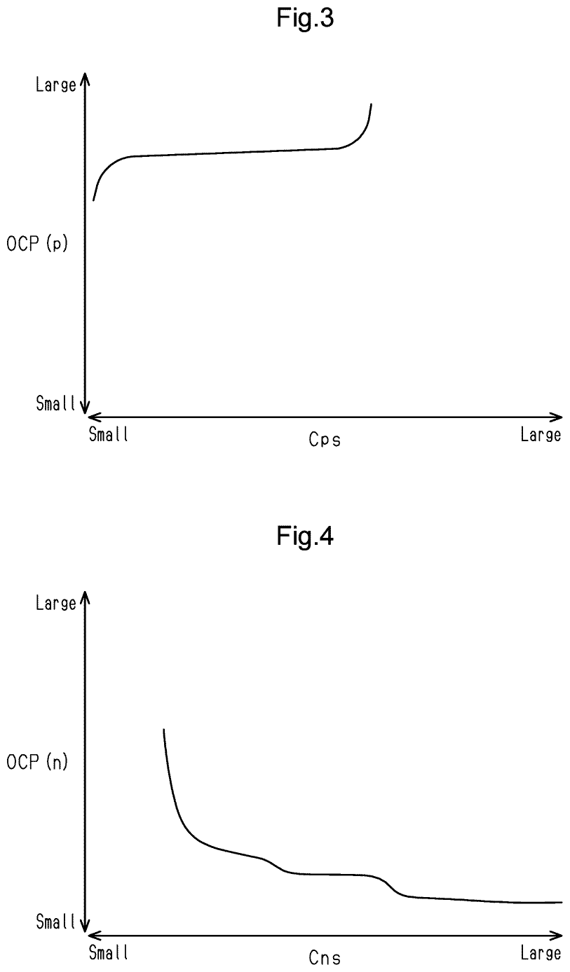

An open-circuit potential OCO(p) of the positive electrode is calculated from the surface concentration Cps of the positive electrode using the map data shown in FIG. 3, which is included in the map data 44b. An open-circuit potential OCO(n) of the negative electrode is calculated from the surface concentration Cns of the negative electrode using the map data shown in FIG. 4, which is included in the map data 44b. The open-circuit voltage of the battery cells 12 is calculated from the open-circuit potentials OCO(p) and OCP(n). Each time the PU 42 executes the process of FIG. 2, the PU42 may use the surface concentrations Cps and Cns to calculate the open-circuit voltages of the battery cells 12.

### Determination of Chargeable Maximum Current Iin

The battery ECU 40 uses the electrochemical model to estimate the surface concentration Cjs when setting a charge current Ic to various values to execute a process for determining a chargeable maximum current Iin.

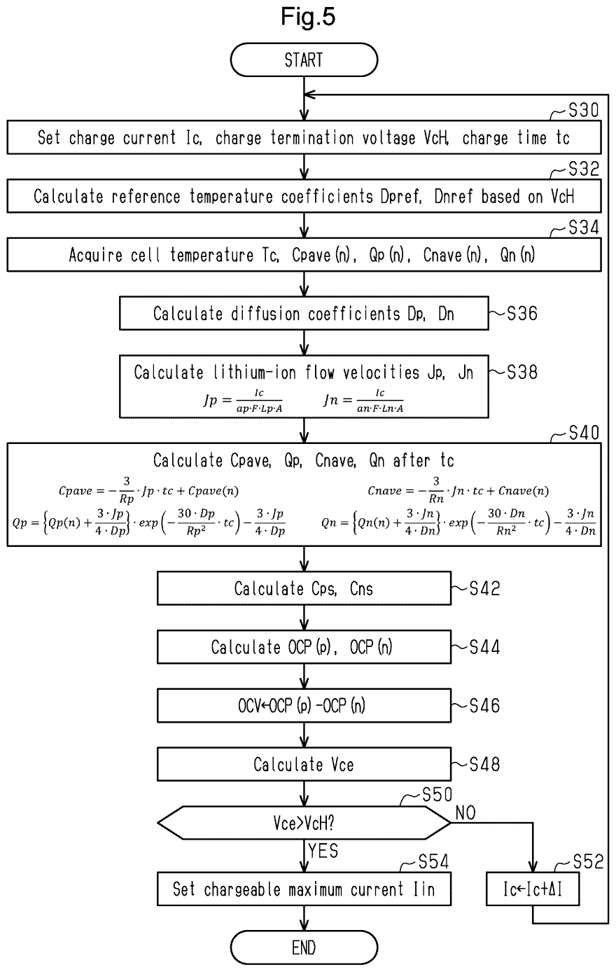

FIG. 5 illustrates the process for determining the chargeable maximum current Iin. The process illustrated in FIG. 5 is implemented by, for example, the PU 42 that executes the programs stored in the storage device 44 repeatedly in predetermined cycles.

In the process illustrated in FIG. 5, the PU 42 first sets the charge current Ic, a charge termination voltage VcH, and a charge time tc (S30). The charge termination voltage VcH is the cell voltage at the end of the charge time tc. The charge termination voltage VcH is set as, for example, the upper limit value of the cell voltage Vc. The charge time the is longer than the time period of the cycle during which the process of FIG. 2 is executed. The charge time tc may be, for example, several tens of times to several thousands of times longer than the execution cycle of FIG. 2. The charge time tc and the charge termination voltage VcH are set only once before the chargeable maximum current Iin is determined. In contrast, the charge current Ic is set a multiple number of times to various values before the chargeable maximum current Iin is determined. The initial value of the charge current Ic when starting the determination is, for example, set to a value expected to be smaller, in absolute value, than the chargeable maximum current Iin.

The PU 42 calculates the reference temperature coefficients Dpref and Dnref based on the input variable of the charge termination voltage VcH (S32). Here, the PU 42 first always assumes that the charge current Ic is zero, and calculates the charge termination voltage VcH from the average concentrations Cpave and Cnave. That is, when the charge-discharge current I is always zero, the lithium-ion flow velocity Jj and the volume average diffusion flux Qj are zero in equation (c8). Thus, it can be assumed that the surface concentrations Cps and Cns are respectively equal to the average concentrations Cpave and Cnave. Accordingly, based on the map data of FIGS. 3 and 4, the PU 42 respectively sets the surface concentrations Cps and Cns, which correspond to the charge termination voltage VcH, to the average concentrations Cpave and Cnave. Further, in the same manner as step S14, the PU 42 uses the input variables of the average concentrations Cpave and Cnave to obtain the reference temperature coefficients Dpref and Dnref by lookup in the map.

The PU 42 acquires the cell temperature Tc and the present average concentrations Cpave and Cnave and the present volume average diffusion fluxes Qp and Qn calculated in the process of FIG. 2 (S34). Further, the PU 42 calculates the diffusion coefficients Dp and Dn based on the cell temperature Te acquired in S34 and the reference temperature coefficients Dpref and Dnref calculated in S32 (S36). The PU 42 also calculates the lithium-ion flow velocities Jp and Jn based on the input variable of the charge current Ic (S38). In this step, the lithium-ion flow velocities Jp and Jn are values acquired by replacing the charge-discharge current I with the charge current Ic in equations (c3) and (c4).

Then, the PU 42 estimates the average concentrations Cpave and Cnave and the volume average diffusion fluxes Qp and Qn at the end of the charge time tc (S40). The input variables in this step are the lithium-ion flow velocities Jp and Jn calculated in S38, the diffusion coefficients Dp and Dn calculated in S36, the present average concentrations Cpave and Cnave, and the present volume average diffusion fluxes Qp and Qn. In S40, the PU 42 fixes the diffusion coefficient Dj in equations (c5) and (c6) to calculate the average concentrations Cpave and Cnave and the volume average diffusion fluxes Qp and Qn at the end of the charge time tc. More specifically, the PU 42 uses equations (c9) and (c10) to calculate the average concentrations Cpave and Cnave and the volume average diffusion fluxes Qp and Qn at the end of the charge time tc.

$$Cjave = - 3 \cdot Jj \cdot tc / Rj + Cjave ( n ) \qquad ( c9 )$$

$$Qj = \{ Qj ( n ) + 3 \cdot Jj / ( 4 \cdot Dj ) \} \cdot exp \{ - 30 \cdot Dj \cdot tc / ( Rj \cdot Rj ) \} - 3 \cdot Jj / ( 4 \cdot Dj ) \qquad ( c10 )$$

Then, the PU 42 estimates the surface concentrations Cps and Cns at the end of the charge time tc based on the input variables of the average concentrations Cpave and Cnave and the volume average diffusion fluxes Qp and Qn at the end of the charge time tc. This step uses equation (c8) in the same manner as S22.

Then, the PU 42 calculates the open-circuit potentials OCO(p) and OCP(n) at the end of the charge time tc based on the input variables of the surface concentrations Cps and Cns at the end of the charge time tc (S44). The step of S44 includes acquiring the open-circuit potential OCO(p) at the end of the charge time tc by lookup in the map based on the input variable of the surface concentration Cps at the end of the charge time tc. Further, the step of S44 includes acquiring the open-circuit potential OCO(n) at the end of the charge time tc by lookup in the map based on the surface concentration Cns at the end of the charge time tc. Here, the map data 44b is used.

Then, the PU 42 substitutes a value obtained by subtracting the open-circuit potential OCO(n) from the open-circuit potential OCO(p) for an open-circuit voltage OCV (S46). Further, the PU 42 calculates an estimated value Vce of the terminal voltage of each battery cell 12 based on the input variables of the charge-discharge current I, the cell temperature Tc, and the open-circuit voltage OCV (S48). The step of S48 includes calculating an overpotential based on the input variables of the charge current Ic and the cell temperature Tc. The calculation of the overpotential may be performed through the Butler-Volmer equation based on the surface concentrations Cps and Cns in addition to the input variables of the charge current Ic and the cell temperature Tc.

Further, the PU 42 determines whether the estimated value Vce is greater than the charge termination voltage (S50). This step determines whether the charge current Ic set in S30 is excessively large. When the PU 42 determines that the estimated value Vce is less than or equal to the charge termination voltage VcH (S50: NO), the PU 42 substitutes a value obtained by adding a predetermined amount AI to the charge current Ic for the charge current Ic (S52) and then returns to S30. This allows the PU 42 to execute the steps of S32 to S50 with the charge current Ic, of which the value is increased by the predetermined amount AI.

When the estimated value Vce is greater than the charge termination voltage VcH (S50: YES), the PU 42 sets the chargeable maximum current Iin to a value obtained by subtracting the predetermined amount AI from the present charge current Ic by (S54).

When S54 is completed, the PU 42 ends the process of FIG. 5.

### Determination of Dischargeable Maximum Current Iout

The battery ECU 40 uses the electrochemical model to estimate the surface concentration Cjs when setting a discharge current Id to various values to execute a process for determining a dischargeable maximum current Iout.

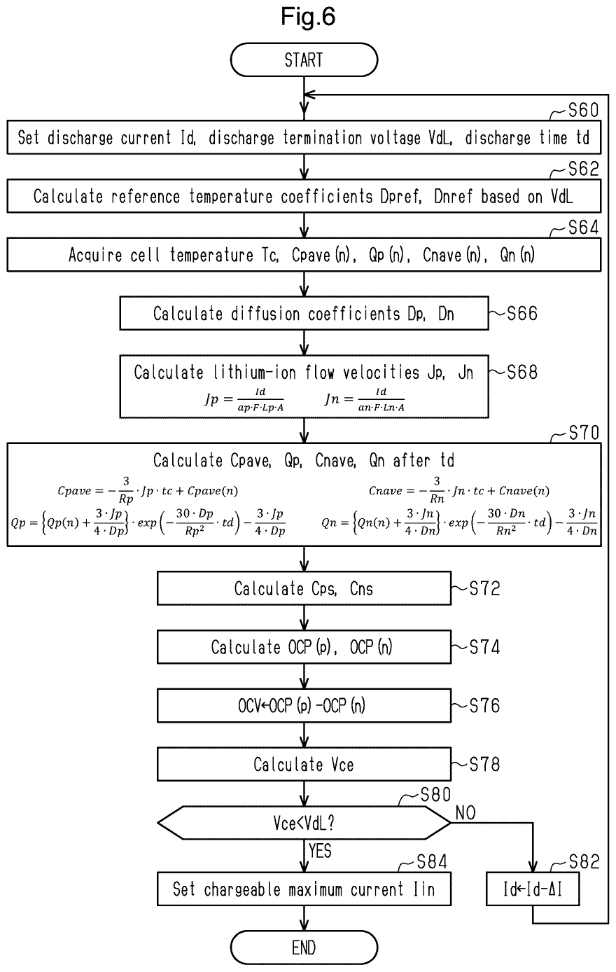

FIG. 6 illustrates the process for determining the dischargeable maximum current Iout. The process illustrated in FIG. 6 is implemented by, for example, the PU 42 that executes the programs stored in the storage device 44 repeatedly in predetermined cycles.

In the process illustrated in FIG. 6, the PU 42 first sets the discharge current Id, a discharge termination voltage VdL, and a discharge time td (S60). The discharge termination voltage VdL is the cell voltage at the end of the discharge time td. The discharge termination voltage VdL is set as, for example, the lower limit value of the cell voltage Vc. The discharge time td is longer than the time period of the cycle during which the process of FIG. 2 is executed. The discharge time td may be, for example, several tens of times to several thousands of times longer than the execution cycle of FIG. 2. The discharge time td and the discharge termination voltage VdL are set only once before the dischargeable maximum current Iout is determined. In contrast, the discharge current Id is set a multiple number of times to various values before the dischargeable maximum current Iout is determined. The initial value of the discharge current Id when starting the determination is, for example, set to a value expected to be smaller, in absolute value, than the dischargeable maximum current Iout.

Then, the PU 42 calculates, in the same manner as in S32, the reference temperature coefficients Dpref and Dnref based on the input variable of the discharge termination voltage VdL (S62). The PU 42 acquires the cell temperature Tc. The PU 42 also acquires the present average concentrations Cpave and Cnave and the present volume average diffusion fluxes Qp and Qn calculated in the process of FIG. 2 (S64). Further, the PU 42 calculates the diffusion coefficients Dp and Dn based on the cell temperature Tc acquired in S64 and the reference temperature coefficients Dpref and Dnref acquired in S62 (S66). Step S66 is similar to step S36. Then, the PU 42 calculates, in the same manner as in S38, the lithium-ion flow velocities Jp and Jn based on the input variable of the discharge current Id (S68).

Further, in the same manner as in S40, the PU 42 estimates the average concentrations Cpave and Cnave and the volume average diffusion fluxes Qp and Qn at the end of the discharge time td (S70). The input variables in this step are the lithium-ion flow velocities Jp and Jn calculated in S68, the diffusion coefficients Dp and Dn calculated in S66, the present average concentrations Cpave and Cnave, and the present volume average diffusion fluxes Qp and Qn. In S70, the PU 42 fixes the diffusion coefficient Dj in equations (c5) and (c6) to calculate the average concentrations Cpave and Cnave and the volume average diffusion fluxes Qp and Qn at the end of the discharge time td.

Then, the PU 42 estimates the surface concentrations Cps and Cns at the end of the discharge time td based on the input variables of the average concentrations Cpave and Cnave and the volume average diffusion fluxes Qp and Qn at the end of the discharge time td (S72).

The PU 42 calculates the open-circuit potentials OCO(p) and OCP(n) at the end of the discharge time td based on the input variables of the surface concentrations Cps and Cns at the end of the discharge time td (S74).

The PU 42 substitutes a value obtained by subtracting the open-circuit potential OCO(n) from the open-circuit potential OCO(p) for the open-circuit voltage OCV (S76). Further, the PU 42 calculates, in the same manner as in S48, the estimated value Vce of the terminal voltage of each battery cell 12 based on the input variables of the charge-discharge current I, the cell temperature Tc, and the open-circuit voltage OCV (S78).

The PU 42 determines whether the estimated value Vce is less than the discharge termination voltage VdL (S80). This step determines whether the discharge current Id set in S60 is excessively large. When the PU 42 determines that the estimated value Vce is less than or equal to the discharge termination voltage VdL (S80: NO), the PU 42 substitutes a value obtained by subtracting the predetermined amount AI from the discharge current Id for the discharge current Id and then returns to S60. This allows the PU 42 to execute the steps of S62 to S80 with the discharge current Id. of which the absolute value is increased by the predetermined amount AI.

When the estimated value Vce is less than the discharge termination voltage VdL (S80: YES), the PU 42 sets the dischargeable maximum current Iout to a value obtained by adding the predetermined amount AI to the present discharge current Id (S84).

When S84 is completed, the PU 42 ends the process of FIG. 6.

### Operation and Advantages of Present Embodiment

The PU 42 tentatively sets the charge current Ic and then calculates the estimated value Vce of the cell voltage when performing charging with the charge current Ic during the charge time tc. The chargeable maximum current Iin is set to the charge current Ic corresponding to the maximum value of the estimated value Vce, which is less than or equal to the charge termination voltage VcH. This allows for maximum charging during the charge time tc.

Further, the PU 42 tentatively sets the discharge current Id and then calculates the estimated value Vce of the cell voltage when performing discharging with the discharge current Id during the discharge time td. The dischargeable maximum current Iout is set to the discharge current Id corresponding to the minimum value of the estimated value Vce, which is greater than or equal to the discharge termination voltage VdL. This allows for maximum discharging during the discharge time td.

The estimated value Vce is based on the electrochemical model. The electrochemical model is set by model variables defining the model data 44a. The model data 44a is generated from the design information of the battery cells 12. Thus, the generation of the model data 44a eliminates the need for performing a number of cycles for charging or discharging the battery cells 12 and collecting a vast amount of data. This shortens the time for increasing the accuracy of the estimated value Vce.

The estimated value Vce is calculated from differential equations expressed by equations (c5) and (c6) and defined by model variables. The diffusion coefficients Dp and Dn in the differential equations are coefficients of the average concentrations Cpave and Cnave that are the solutions of the differential equations. The average concentrations Cpave and Cnave may vary greatly over the periods of the charge time tc and the discharge time td. If the periods of the charge time tc and the discharge time td were to be divided into fine-grained time intervals and a difference equation discretizing the differential equation were to be solved in each time period, the computation load for calculating the estimated value Vce would become excessively large.

In the present embodiment, the diffusion coefficients Dp and Dn are fixed so that the cell voltage at the end of the charge time tc and the discharge time td can be estimated through a single calculation. This reduces the computation load.

When the battery cells 12 deteriorate, the profiles of the open-circuit potentials OCO(p) and OCP(n) in FIGS. 3 and 4 may be changed to calculate the estimated value Vce that is suitable for the deteriorated battery cells 12. In this respect, if an equivalent circuit model of an electrochemical model were to be employed and circuit parameters of the equivalent circuit model were to be fitted using time-series data of detected physical quantities resulting from charging and discharging of the battery cell 12, it would be necessary to redo the fitting operation so as to cope with the deterioration.

The present embodiment described above further has the following operation and advantages.
(1) The diffusion coefficients Dp and Dn used to calculate the estimated value Vce at the end of the charge time tc are set based on the average concentrations Cpave and Cnave that correspond to the charge termination voltage VcH. The average concentrations Cpave and Cnave, which are set in this manner, become closer to the actual average concentrations Cpave and Cnave as charging results in the cell voltage becoming closer to the charge termination voltage VcH. This allows the terminal voltage to be estimated with high accuracy when using the charge current Ic that results in the cell voltage Ve becoming close to the charge termination voltage VcH when the charge time to ends.
(2) The diffusion coefficients Dp and Dn used to calculate the estimated value Vce at the end of the discharge time td are set based on the average concentrations Cpave and Cnave corresponding to the discharge termination voltage VdL. The average concentrations Cpave and Cnave, which are set in this manner, become closer to the actual average concentrations Cpave and Cnave as discharging results in the cell voltage becoming closer to the discharge termination voltage VdL. This allows the terminal voltage to be estimated with high accuracy when using the discharge current Id that results in the cell voltage Vc becoming closer to the discharge termination voltage VdL when the discharge time td ends.

### Corresponding Relationship

The corresponding relationship of the elements in the above embodiment and the elements in the Summary section will now be described. The corresponding relationship will be described in association with the example numbers in the Summary section.

In examples 1 and 2, the processor corresponds to the PU 42. The storage device corresponds to the storage device 44. The model variables correspond to the reference temperature coefficients Dpref and Dnref, the diffusion coefficients Dp and Dn, the particle sizes Rp and Rn, the active material thicknesses Lp and Ln, and the electrode activation energies Eap and Ean. The model variables correspond to the cross-sectional area A, the positive electrode thickness Lp, the negative electrode thickness Ln, the positive electrode active material surface area of per unit volume ap, and the negative electrode active material surface area per unit volume an. The concentration of the predetermined substance corresponds to the concentration of lithium-ions. The concentration variable estimation process corresponds to S34 to S42 and S64 to S72. The predetermined model variable corresponds to the reference temperature coefficients Dpref and Dnref and the diffusion coefficients Dp and Dn.

In example 3, the related data corresponds to the data that is illustrated in FIGS. 3 and 4 and included in the map data 44b. The diffusion level variable corresponds to the volume average diffusion fluxes Qp and Qn. The voltage estimation process corresponds to S44 to S48 and S64 to S68. The concentration variable in the surface of the active material corresponds to the surface concentrations Cps and Cns.

In example 4, the diffusion coefficient setting process corresponds to S62 to S66. The predetermined discharge voltage corresponds to the charge termination voltage VcH.

In example 5, the diffusion coefficient setting process corresponds to S32 to S36. The predetermined discharge voltage corresponds to the discharge termination voltage VdL.

In example 6, the current value setting process corresponds to S30 and S60. The determination process corresponds to S54 and S84. The restriction variable corresponds to the chargeable maximum current Iin and the dischargeable maximum current Iout.

In example 7, the diffusion coefficient calculation process corresponds to S12 to S16. The first equation corresponds to equation (c5). The second equation corresponds to equation (c6). The third equation corresponds to equation (c8).

In example 8, the acquisition process corresponds to S10. The concentration variable calculation process corresponds to S18 to S22.

### OTHER EMBODIMENTS

The above embodiment may be modified as described below. The above embodiment and the modified examples described below may be combined as long as there is technical consistency.

### Diffusion Coefficient

In the processes for calculating the reference temperature coefficients Dpref and Dnref, the input variables do not have to be the average concentrations Cpave and Cnave. The input variable may be, for example, the surface concentrations Cps and Cns and the volume average diffusion fluxes Qp and Qn.

The processes for calculating the diffusion coefficients Dp and Dn do not have to calculate the product of a coefficient that is dependent on temperature and the reference temperature coefficients Dpref and Dnref. The processes may, for example, acquire the diffusion coefficients Dp and Dn by lookup in the map data in which the input variables are the average concentrations Cpave and Cnave and the cell temperature Tc and the output variables are the diffusion coefficients Dp and Dn.

### Electrochemical Model

The diffusion level variable is not limited to the volume average diffusion fluxes Qp and Qn. For example, the diffusion level variables may be the average concentrations Cps-Cpave and Cns-Cnave.

In the above embodiment, the concentration of the active material is not limited to a model including an item that is not dependent on the distances rp and rn from the origin of the active material in the radial direction, an item proportional to the square of the distances rp and rn, and an item proportional to the fourth power of the distances rp and rn. When the equation based on the electrochemical model is a non-linear equation, the equation may be converted to a linear equation that is used to estimate the concentration variable. In such a case, the value of a predetermined model variable in the linear equation may be fixed to estimate the concentration variable through a single calculation.

### Diffusion Coefficient Setting Process

The predetermined discharge voltage used to calculate the reference temperature coefficients Dpref and Dnref does not have to be the discharge termination voltage VdL. The predetermined discharge voltage may be, for example, the average value or the like of the present cell voltage Vc and the discharge termination voltage VdL or a value closer to the discharge termination voltage VdL than the present cell voltage Vc.

The predetermined charge voltage used to calculate the reference temperature coefficients Dpref and Dnref does not have to be the charge termination voltage VcH. The predetermined charge voltage may, for example, be the average value or the like of the present cell voltage Vc and the charge termination voltage VcH or be closer to the charge termination voltage VcH than the present cell voltage Vc.

### Predetermined Location of Predetermined Substance Concentration

The predetermined location in the rechargeable battery where the concentration of the predetermined material changes over time is not limited to where the active material is located. For example, the predetermined location may be where the electrolyte solution is located in the rechargeable battery. In this case, the concentration variable may be, for example, a variable representing the salt concentration in the electrolyte solution. In this case, when estimating changes in the salt concentration over time using a liquid phase diffusion equation, the predetermined model variable is fixed to reduce the computation load. In this case, the predetermined model variable may be a diffusion coefficient in the diffusion coefficient of the liquid phase.

### Restriction Variable

In the above embodiment, the restriction variables of the chargeable maximum current Iin and the dischargeable maximum current Iout are set based on the estimated value Vce of the terminal voltage related to one of the battery cells 12 in the on-board battery 10. This, however, is not a limitation. For example, the average value of the chargeable maximum current Iin and the average value of the dischargeable maximum current Iout that are set based on the estimated value Vce of the terminal voltage related to each of the battery cells 12 may be set as the final chargeable maximum current Iin and the final dischargeable maximum current Iout.

### Simulator

The simulator does not have to be implemented by a PU that executes processes. The simulator may include, for example, a dedicated hardware circuit, such as an application-specific integrated circuit (ASIC), executing at least a part of the processes executed in the above embodiment. More specifically, the simulator may include any one of the processing circuitries described below in (a) to (c). (a) Processing circuitry including a processor that executes all of the above processes in accordance with programs, and a program storing device such as a storage device that stores the programs. (b) Processing circuitry including a processor that executes some of the above processes in accordance with programs, a program storing device, and a dedicated hardware circuit that executes the remaining processes. (c) Processing circuitry including a dedicated hardware circuit that executes all of the processes. There may be more than one software execution device or dedicated hardware circuit that includes a processor and a program storing device.

### Rechargeable Battery

The rechargeable battery does not have to be installed in a vehicle.

The rechargeable battery is not limited to a lithium-ion rechargeable battery. The rechargeable battery may be, for example, a nickel metal-hydride rechargeable battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rechargeable battery simulator, comprising:
a storage device; and
a processor, wherein
the storage device stores model variables that define an electrochemical model of a rechargeable battery,
the processor is configured to execute a concentration variable estimation process,
the concentration variable estimation process includes estimating a concentration variable varied by current flowing through the rechargeable battery using an equation in which a predetermined model variable of the model variables has a fixed value,
the concentration variable represents a concentration of a predetermined substance at a predetermined location in the rechargeable battery, and
the equation specifies time variation of the concentration variable.

2. The rechargeable battery simulator according to claim 1, wherein:
the predetermined model variable includes a diffusion coefficient of a diffusion equation related to the predetermined substance; and
the concentration variable estimation process includes estimating a value of the concentration variable, varied by current flowing through the rechargeable battery, using the equation in which the diffusion coefficient has a fixed value.

3. The rechargeable battery simulator according to claim 1, wherein:
the concentration variable represents an ion concentration in a surface of an active material;
the storage device stores related data that sets a relationship between the concentration variable and an open-circuit potential;
the processor is configured to execute a voltage estimation process;
the equation includes a first equation that associates an average concentration of ions in the active material with its first-order time derivative;
the concentration variable estimation process includes estimating the average concentration with the first equation and estimating the concentration variable from the estimated average concentration; and
the voltage estimation process includes estimating a terminal voltage of the rechargeable battery that corresponds to the concentration variable by using the related data.

4. The rechargeable battery simulator according to claim 3, wherein:
the processor is configured to execute a diffusion coefficient setting process;
the diffusion coefficient setting process includes setting a diffusion coefficient, as the predetermined model variable, in correspondence with a predetermined discharge voltage;
the concentration variable estimation process includes estimating the concentration variable using the diffusion coefficient corresponding to the predetermined discharge voltage; and
the predetermined discharge voltage is a voltage closer to a discharge termination voltage of the rechargeable battery than a present terminal voltage of the rechargeable battery.

5. The rechargeable battery simulator according to claim 3, wherein:
the processor is configured to execute a diffusion coefficient setting process;
the diffusion coefficient setting process includes setting a diffusion coefficient, as the predetermined model variable, in correspondence with a predetermined charge voltage;
the concentration variable estimation process includes estimating the concentration variable using the diffusion coefficient corresponding to the predetermined charge voltage; and
the predetermined charge voltage is a voltage closer to a charge termination voltage of the rechargeable battery than a present terminal voltage of the rechargeable battery.

6. The rechargeable battery simulator according to claim 3, wherein:
the processor is configured to execute a current value setting process and a determination process;
the current value setting process includes setting current values of the rechargeable battery as conditions for estimating the concentration variable in the concentration variable estimating process;
the determination process includes determining a restriction variable based on the terminal voltage corresponding to the concentration variable estimated using the current values set in the current value setting process; and
the restriction variable represents a restriction imposed on a current of the rechargeable battery.

7. The rechargeable battery simulator according to claim 3, wherein:
in addition to the first equation associating the average concentration of ions with its first-order time derivative, the equation includes a second equation that associates a diffusion level variable with its first-order time derivative, and a third equation that associates the average concentration and the diffusion level variable with the concentration variable;
the diffusion level variable represents a diffusion level of the ions in the active material; and
the concentration variable estimation process includes estimating the average concentration and the diffusion level variable with the first equation and the second equation, and estimating the concentration variable with the third equation based on input variables of the average concentration and the diffusion level variable.

8. The rechargeable battery simulator according to claim 3, wherein:
the processor is configured to repeatedly execute a diffusion coefficient calculation process, an acquisition process, and a concentration variable calculation process;
the diffusion coefficient calculation process includes calculating a diffusion coefficient based on the average concentration;
the acquisition process includes acquiring a current flowing through the rechargeable battery;
the concentration variable calculation process includes calculating an average concentration of ions in the active material using an equation defined by the diffusion coefficient calculated by the diffusion coefficient calculating process based on an input variable of the current; and
the concentration variable estimation process includes estimating a future value expected at a future time point over a time period that is longer than execution cycles of the diffusion coefficient calculation process, the acquisition process, and the concentration variable calculation process, and using a value calculated through the concentration variable calculation process as an initial value of the average concentration.

9. A vehicle comprising:
the rechargeable battery simulator according to claim 6,
drive wheels;
a motor generator mechanically coupled to the drive wheels;
the secondary battery configured to discharge electric power for driving the motor generator or to be charged with regenerative electric power generated by the motor generator; and
a controller configured to control amount of electric power charged to and discharged from the secondary battery,
wherein:
the restriction variable includes a chargeable maximum current and a dischargeable maximum current; and
the controller is further configured to set a charge-discharge current of the secondary battery based on the chargeable maximum current and the dischargeable maximum current.
